(19) United States
(12) Patent Application Publication
(10) Pub. No.: US 2026/0348464 A1
(43) Pub. Date: Nov. 5, 2026

(54) DIFFERENTIAL AND VEHICLE TRANSMISSION

(71) Applicant: Schaeffler Technologies AG & Co. KG, Herzogenaurach (DE)

(72) Inventors: Yan Zhuang, Shanghai (CN); Lei Liu, Shanghai (CN)

(73) Assignee: Schaeffler Technologies AG & Co. KG, Herzogenaurach (DE)

(21) Appl. No.: 19/484,929

(22) PCT Filed: May 15, 2023
(86) PCT No.: PCT/CN2023/094132

§ 371 Date: Nov. 17, 2025

(51) Int. Cl. F16H 48/08; F16H 48/38; F16H 48/40

(52) U.S. Cl. CPC F16H 48/08; F16H 48/40; F16H 2048/385

(57) ABSTRACT

A differential, having a ring gear; a housing, having a first split part and a second split part which have the same structure, the first split part and the second split part are coaxially arranged with the ring gear, the first split part and the second split part are detachably mounted together with the ring gear, the first split part and the second split part are respectively in spline connection with the ring gear to implement transmission connection, and the first split part and the second split part define a mounting space; and a bevel gear group, accommodated and mounted in the mounting space. Therefore, the housing with enough precision is obtained without additional finish machining, and the housing achieves dynamic balance in the working process of the differential. In addition, the structure of the differential facilitates disassembly and assembly, torque transmission, and simplification of the manufacturing and assembling processes.

### CROSS-REFERENCE TO RELATED APPLICATIONS

This application claims priority to PCT Application PCT/CN2023/094132, filed May 15, 2023. The disclosure of the above application is incorporated herein by reference.

### FIELD OF THE INVENTION

The present application relates to the field of wheel differential for vehicles, and specifically to a differential and a vehicle transmission having the differential.

### BACKGROUND OF THE INVENTION

In the state of art, a differential is commonly used in the transmission mechanism of a vehicle to transmit torque from the vehicle's transmission to the wheels and to enable different wheels to rotate at different speeds when the vehicle is turning. A bevel gear differential is a typical differential used in the transmission mechanism of a vehicle.

In a prior-art bevel gear differential, an integral housing is used. In this case, the structure of the integral housing is complex, which leads to complex structures of manufacturing tools for molding and the like, and a cumbersome molding process. Moreover, in an aspect, in the manufacturing process of such an integral housing, a blank is typically first produced by sand casting and then machined to obtain the integral housing. Since the precision of sand casting is poor, the blank is prone to defects such as shrinkage porosity and cavity, so it is necessary to perform finish machining on the casted blank (especially the parts to be fitted with other components). In another aspect, in order to ensure the dynamic balance of such an integral housing in the working process of the differential, special tools are also usually required to perform finish machining on the blank.

In another prior-art bevel gear differential, a split housing is used. In this case, the split housing is fixed to the ring gear, which serves as an input element of the differential, in a non-detachable manner such as welding, resulting in damage to the differential during disassembly.

### SUMMARY OF THE INVENTION

The present application has been made in view of the defects of the prior art as described above. It is an objective of the present application to provide a differential, which has a relatively simple structure and is non-destructively assembled and disassembled. Moreover, for such a differential, a housing with enough precision is obtained without additional finish machining, and the housing achieves dynamic balance in the working process of the differential. It is a further objective of the present application to provide a vehicle transmission having the differential.

To achieve the foregoing objectives, the following technical solutions are used in the present application.

The present application provides a differential, having:
a ring gear;
a housing having a first split part and a second split part which have the same structure, wherein the first split part and the second split part are coaxially arranged with the ring gear, the first split part and the second split part are detachably mounted together with the ring gear, the first split part and the second split part are respectively in spline connection with the ring gear to implement transmission connection, and the first split part and the second split part define a mounting space; and
a bevel gear group accommodated and mounted in the mounting space, the bevel gear group having a gear shaft, a first pair of bevel gears, and a second pair of bevel gears, wherein the gear shaft extends along a radial direction of the ring gear and is in transmission connection with the ring gear, the two bevel gears of the first pair of bevel gears are mounted to the gear shaft and are rotatable around the gear shaft, and each bevel gear of the second pair of bevel gears meshes with a corresponding bevel gear of the first pair of bevel gears.

In an alternative solution, the ring gear is formed with at least one ring groove, the differential includes at least one retaining ring, and the at least one retaining ring is mounted to the at least one ring groove for axially limiting the first split part and the second split part.

In another alternative solution, the ring gear is formed with two mounting grooves, and two axial ends of the gear shaft are respectively inserted into the two mounting grooves, thereby enabling the ring gear to directly drive the gear shaft to rotate.

In another alternative solution, the ring gear has an annular shape, the ring gear is provided with a first inner spline and a second inner spline on an inner circumferential surface thereof, and the first inner spline and the second inner spline are arranged side-by-side and spaced apart from one another in an axial direction of the ring gear,
the first split part is provided with a first outer spline, the first outer spline and the first inner spline mesh with each other, the second split part is provided with a second outer spline, and the second outer spline and the second inner spline mesh with each other.

In another alternative solution, the ring gear has a central protrusion, and the central protrusion is located between the first inner spline and the second inner spline in the axial direction,
the ring gear is formed with a first ring groove, the differential further includes a first retaining ring, the first retaining ring is mounted into the first ring groove, and the first retaining ring and the central protrusion are located on two axial sides of the first outer spline for axially limiting the first outer spline, and
the ring gear is further formed with a second ring groove, the differential further includes a second retaining ring, the second retaining ring is mounted into the second ring groove, and the second retaining ring and the central protrusion are located on two axial sides of the second outer spline for axially limiting the second outer spline.

In another alternative solution, the central protrusion is formed with two mounting grooves, two end portions of the gear shaft form mounting portions corresponding to the mounting grooves, and the mounting portions are inserted into corresponding mounting grooves.

In another alternative solution, the mounting groove is a U-shaped groove, the mounting groove includes two planar side walls that are parallel to each other, the mounting portion is formed with an abutting portion that is in form-fit with and in contact with the two side walls, and the side walls cooperate with the abutting portion to implement transmission connection.

In another alternative solution, there is a plane of symmetry that is perpendicular to the axial direction of the ring gear, and the differential as a whole has a structure that is symmetrical with respect to the plane of symmetry.

In another alternative solution, the first split part and the second split part are formed by using the same fine blanking apparatus for machining.

The present application further provides a vehicle transmission, including the differential according to any one of the preceding technical solutions.

By employing the above technical solutions, the present application provides a differential, which includes a ring gear, a housing, and a bevel gear group. Typically, the ring gear receives torque from outside the differential, and the bevel gear group transmits torque to the outside of the differential. The housing includes a first split part and a second split part which have the same structure, and the first split part and the second split part are coaxially arranged with the ring gear. The first split part and the second split part are detachably mounted together with the ring gear, and the first split part and the second split part are respectively in spline connection with the ring gear, thereby achieving a transmission connection between the housing and the ring gear. In addition, the first split part and the second split part define a mounting space, and the bevel gear group is accommodated and mounted in the mounting space. The bevel gear group includes two pairs of bevel gears meshing with each other. Bevel gears of one pair of bevel gears are mounted to the gear shaft so as to be rotatable around the central axis of the ring gear along with the gear shaft, and the bevel gears of this pair are rotatable around the gear shaft. The other pair of bevel gears meshes with the one pair of bevel gears to transmit torque to the wheels of a vehicle, for example, via a half-shaft. Also, the present application provides a vehicle transmission including the above-mentioned differential.

In this way, since the housing of the differential of the present application employs a split structure design and the two split parts of the housing have the same structure, the two split parts may be formed by employing a fine blanking process. Thus, the housing with enough precision is obtained without additional finish machining, and the mass distribution of the two split parts of the housing is symmetrical and uniform without additional finish machining, thereby enabling the housing to achieve dynamic balance in the working process of the differential. Moreover, the housing and the ring gear are detachably mounted together and the two split parts are in spline connection with the ring gear, so the differential is disassembled without damaging the structures of the housing and the ring gear, and compared to the case where welding, bolted connection and the like are used, greater torque is transmitted. Further, the structure of the differential of the present application is relatively simple, which facilitates simplification of the manufacturing and assembling processes. Additionally, the vehicle transmission including the above-mentioned differential has the same beneficial effects.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic cross-sectional view showing a differential according to an embodiment of the present application, in which section lines are omitted.

FIG. 2 is a schematic exploded view showing the differential in FIG. 1.

FIG. 3 is a schematic perspective view showing a ring gear of the differential in FIG. 1.

FIG. 4 is a schematic perspective view of a first retaining ring of the differential in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

Specific embodiments of the present application are described in detail below with reference to the accompanying drawings of the specification. It is to be understood that these specific descriptions are only used to teach those skilled in the art how to implement the present application, and are neither intended to be exhaustive of all possible implementations of the present application nor to limit the scope of the present application.

In the present application, “transmission connection” refers to a connection between two components that are capable of transmitting torque, including a direct connection and an indirect connection.

In the present application, unless otherwise specified, “axial,” “radial,” and “circumferential” refer to the axial, radial, and circumferential directions of the ring gear, respectively.

The structure of a differential of an embodiment of the present application is described below with reference to the accompanying drawings of the specification.

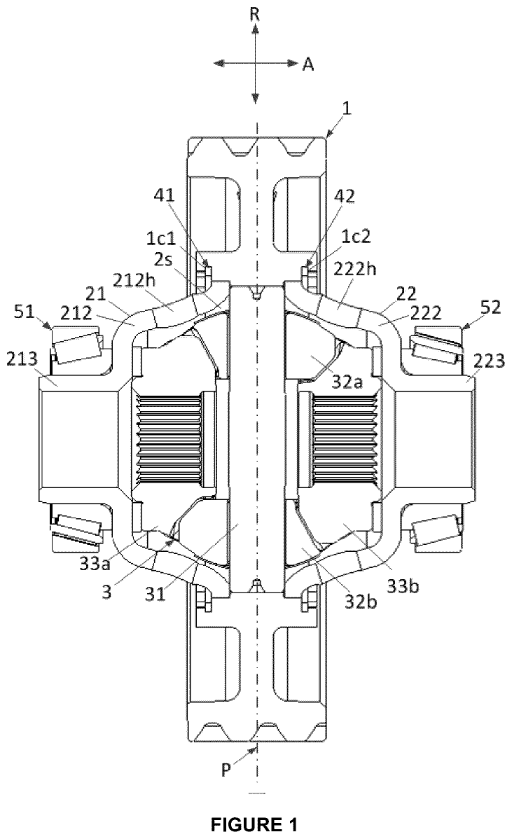

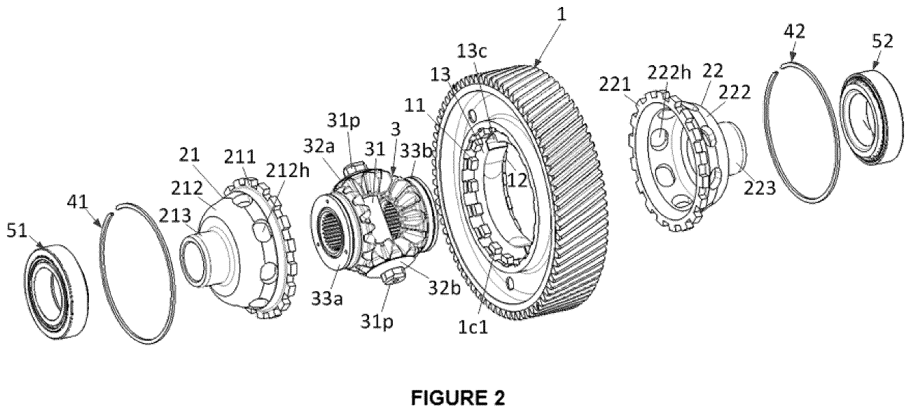

As shown in FIG. 1 and FIG. 2, a differential according to an embodiment of the present application includes a ring gear 1, a housing (a first split part 21 and a second split part 22), a bevel gear group 3, two retaining rings 41, 42, and two bearings 51, 52, all of which are assembled together. As shown in FIG. 1, the differential as a whole has a structure that is symmetrical with respect to a plane of symmetry P (denoted with a single dot-dashed line in FIG. 1), and the plane of symmetry P is perpendicular to an axial direction A. Symmetry here means that the overall structural layout of the differential is substantially symmetrical, but not necessarily completely and precisely symmetrical. For example, in this embodiment, outer teeth of the ring gear 1 may have a shape that is asymmetrical with respect to the plane of symmetry P. As an example, the ring gear 1 shown in FIG. 2 is a helical gear.

In this embodiment, the ring gear 1 may, for example, be in transmission connection with an output gear of an output shaft of a vehicle's transmission, so that torque from outside the differential is transmitted to the ring gear 1. Here, as an example, the ring gear 1 may be an outer ring gear. As shown in FIG. 1, the ring gear 1 has an annular shape, and the ring gear 1 is arranged coaxially with the housing and a second pair of bevel gears 33a, 33b of the bevel gear group 3.

As shown in FIGS. 1-3, the ring gear 1 is provided with a first inner spline 11, a second inner spline 12, and a central protrusion 13 on its inner circumferential surface. The first inner spline 11, the second inner spline 12, and the central protrusion 13 are arranged side-by-side in the axial direction A. The central protrusion 13 is located between the first inner spline 11 and the second inner spline 12 in the axial direction A, so that the first inner spline 11 and the second inner spline 12 are arranged spaced apart by the central protrusion 13 in the axial direction A.

As shown in FIGS. 1-3, the ring gear 1 is further formed with a first ring groove 1c1 and a second ring groove 1c2. With respect to the first inner spline 11, the first ring groove 1c1 is located on a side opposite to a side where the central protrusion 13 is located (the left side of FIG. 1), and the first ring groove 1c1 is configured for inserting and mounting the first retaining ring 41. With respect to the second inner spline 12, the second ring groove 1c2 is located on a side opposite to a side where the central protrusion 13 is located (the right side of FIG. 1), and the second ring groove 1c2 is used for inserting and mounting the second retaining ring 42.

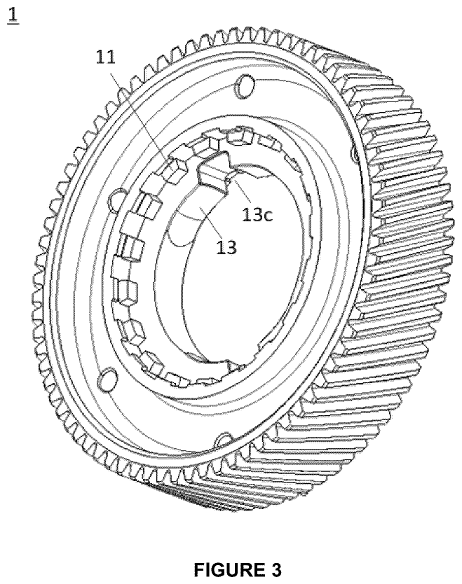

As shown in FIG. 2 and FIG. 3, the central protrusion 13 is formed with two mounting grooves 13c corresponding to mounting portions 31p of a gear shaft 31 of the bevel gear group 3. The two mounting grooves 13c are spaced apart by a central angle of 180 degrees and have the same shape. As shown in FIG. 3, each mounting groove 13c is a U-shaped groove, and its cross-section has a square shape corresponding to the mounting portion 31p of the gear shaft 31. Circumferential side wall surfaces of the mounting groove 13c are formed as planes parallel to each other for abutting against and cooperating with the mounting portion 31p of the gear shaft 31.

In this embodiment, as shown in FIG. 1 and FIG. 2, the housing is a rotating body with a central axis. A cross-sectional shape of the rotating body at any axial position is an annular shape, and the housing as a whole is rotatable around the central axis. Specifically, the housing has the first split part 21 and the second split part 22 which have the same structure. The first split part 21 and the second split part 22 are arranged coaxially with the ring gear 1 and are symmetrically arranged with respect to the plane of symmetry P. The first split part 21 and the second split part 22 are detachably mounted together with the ring gear 1, such that the housing is in transmission connection with the ring gear 1. Furthermore, the first split part 21 and the second split part 22 define a mounting space 2s.

As shown in FIG. 1 and FIG. 2, the first split part 21 includes a first outer spline 211, a first tapered portion 212, and a first bearing seat 213 that are integrally formed. The first outer spline 211 meshes with the first inner spline 11 of the ring gear 1. A large-diameter end of the first tapered portion 212 is connected to a root of the first outer spline 211, and a small-diameter end of the first tapered portion 212 is connected to the first bearing seat 213. The second split part 22 includes a second outer spline 221, a second tapered portion 222, and a second bearing seat 223 that are integrally formed. The second outer spline 221 meshes with the second inner spline 12 of the ring gear 1. A large-diameter end of the second tapered portion 222 is connected to a root of the second outer spline 221, and a small-diameter end of the second tapered portion 222 is connected to the second bearing seat 223. Furthermore, to reduce the weight of the housing, the first tapered portion 212 is formed with a plurality of first weight-reducing holes 212h distributed and spaced apart from one another in a circumferential direction, and the second tapered portion 222 is formed with a plurality of second weight-reducing holes 222h distributed and spaced apart from one another in a circumferential direction. Since the first split part 21 and the second split part 22 have the same structure, the first split part 21 and the second split part 22 may be formed by using the same fine blanking apparatus for fine blanking. Moreover, the housing with enough precision may be obtained without needing to perform additional finish machining on the first split part 21 and the second split part 22, and the housing is also enabled to achieve dynamic balance in the working process of the differential.

In this embodiment, as shown in FIG. 1 and FIG. 2, the bevel gear group 3 is accommodated and mounted in the mounting space 2s defined by the first split part 21 and the second split part 22. The bevel gear group 3 includes the gear shaft 31, a first pair of bevel gears (a first bevel gear 32a and a second bevel gear 32b), and the second pair of bevel gears (a third bevel gear 33a and a fourth bevel gear 33b).

As shown in FIG. 1, the gear shaft 31 extends along a radial direction R of the ring gear 1 and is in transmission connection with the ring gear 1. Specifically, the gear shaft 31 is detachably inserted into the mounting grooves 13c of the central protrusion 13 of the ring gear 1 along the radial direction R. The gear shaft 31 is configured for mounting the first pair of bevel gears such that the first bevel gear 32a and the second bevel gear 32b of the first pair of bevel gears may rotate along with the gear shaft 31 and the housing as a whole, and at the same time, the first bevel gear 32a and the second bevel gear 32b may also rotate independently around the gear shaft 31. Further, two end portions of the gear shaft 31 form the mounting portions 31p corresponding to the mounting grooves 13c, and the mounting portions 31p are inserted into corresponding mounting grooves 13c. The mounting portion 31p may be formed with an abutting portion that is in form-fit with and in contact with the two circumferential side wall surfaces of the mounting groove 13c, and the two circumferential side wall surfaces cooperate with the abutting portion to implement transmission connection between the ring gear 2 and the gear shaft 31. To enable the gear shaft 31 to be rotatable along with the ring gear 1 without resulting in relative rotation with respect to the ring gear 1 upon the cooperation between the mounting portions 31p and the mounting grooves 13c, the cross-section of the mounting portion 31p may be formed into a square shape. By utilizing the cooperation between the mounting grooves 13c of the ring gear 1 and the mounting portions 31p, on the one hand, a contact area between the gear shaft 31 and the ring gear 1 is large enough to facilitate the transmission of larger torque; on the other hand, relative rotation between the gear shaft 31 and the ring gear 1 is prevented.

As shown in FIG. 1 and FIG. 2, the first bevel gear 32a and the second bevel gear 32b of the first pair of bevel gears are mounted to the gear shaft 31 and are rotatable around the gear shaft 31. The third bevel gear 33a of the second pair of bevel gears meshes with both the first bevel gear 32a and the second bevel gear 32b of the first pair of bevel gears, and the fourth bevel gear 33b of the second pair of bevel gears meshes with both the first bevel gear 32a and the second bevel gear 32b of the first pair of bevel gears. The third bevel gear 33a and the fourth bevel gear 33b are both formed with an inner spline that cooperates with an outer spline of a half-shaft, so that the differential may output torque to the half-shaft via the bevel gear group 3.

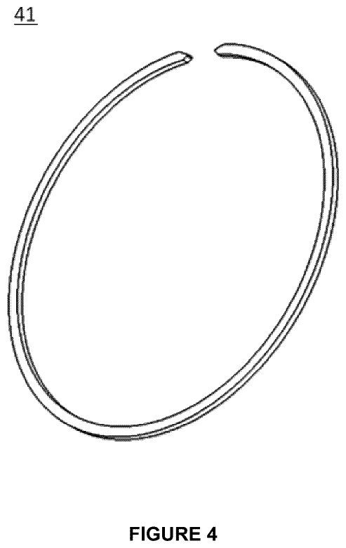

In this embodiment, as shown in FIG. 1, FIG. 2 and FIG. 4, the first retaining ring 41 and the second retaining ring 42 have the same structure and are both formed into a C-shape. The first retaining ring 41 is mounted into the first ring groove 1c1 and protrudes radially inward relative to the first ring groove 1c1. The first retaining ring 41 and the central protrusion 13 are located on two axial sides of the first outer spline 211 for axially limiting the first outer spline 211. The second retaining ring 42 is mounted into the second ring groove 1c2 and protrudes radially inward relative to the second ring groove 1c2. The second retaining ring 42 and the central protrusion 13 are located on two axial sides of the second outer spline 221 for axially limiting the second outer spline 221.

In this embodiment, as shown in FIG. 1 and FIG. 2, the first bearing 51 and the second bearing 52 may both be single-row tapered roller bearings. An inner ring of the first bearing 51 is sleeved onto the first bearing seat 213, and an inner ring of the second bearing 52 is sleeved onto the second bearing seat 223. The two bearings 51, 52 are mounted to the housing in such a way that their respective inner rings are fixed to axial end portions of the housing. The two bearings 51, 52 are configured to support the housing of the differential such that the differential may rotate and work properly.

The specific technical solutions of the present application have been described in detail above, but the present application is not limited to the above-mentioned technical solutions, and supplementary explanations are given below.
i. The above-mentioned split housing has a relatively simple structure and may be formed not only by a fine blanking apparatus, but also manufactured by processes such as precision forging, thereby improving the machining accuracy of the housing and the strength of components. Since the first split part 21 and the second split part 22 have the same structure and are symmetrically arranged, the housing composed of the first split part 21 and the second split part 22 achieves dynamic balance in the working process of the transmission even without additional machining. Moreover, in the case of using a fine blanking apparatus for machining, the first split part 21 and the second split part 22 may be formed by using the same fine blanking apparatus for machining, thereby significantly reducing the manufacturing costs.
ii. In the above-mentioned embodiments, since the housing and the ring gear 1 are in transmission connection via splines, and the cooperation between the structure of the ring gear 1 itself (the central protrusion 13) and the retaining rings 41, 42 are utilized for axially limiting the first split part 21 and the second split part 22, the above-mentioned structure thus not only makes the structure of the differential relatively simple, but also allows for the disassembly and assembly of the differential without damaging the structure of the differential, thereby reducing the maintenance costs of the differential, etc.

It is appreciated that, in an alternative solution, the inner spline of the ring gear 1 may extend continuously along the axial direction A of the ring gear 1 (rather than forming a discontinuous structure as described in the above-mentioned embodiments), and the central protrusion 13 of the ring gear 1 may be omitted. In this case, the first split part 21 and the second split part 22 of the housing may abut against each other in the axial direction A, and the cooperation with retaining rings 41, 42 is utilized for axially limiting the first split part 21 and the second split part 22, thereby achieving the same effects as those of the above-mentioned embodiments.

It is appreciated that, in another alternative solution, the inner spline of the ring gear 1 may extend continuously along the axial direction A of the ring gear 1 (rather than forming a discontinuous structure as described in the above-mentioned embodiments), and the central protrusion 13 of the ring gear 1 may be omitted. Moreover, one of the retaining rings 41, 42 may be integrally formed with the ring gear 1. That is to say, the ring gear 1 is formed with a limiting protrusion for axial limit. The limiting protrusion cooperates with the other of the retaining rings 41, 42 for axially limiting the first split part 21 and the second split part 22, thereby achieving the same effects as those of the above-mentioned embodiments.
iii. It is appreciated that, compared with the case where portions of the split housing are connected by multiple bolts, the use of multiple bolts may be eliminated, which results in a reduced number of parts and allows for quicker assembly. The radial space for the mounting bolts of the housing may be reduced or omitted so as to provide a more compact size for the differential and reduce material costs, which facilitates lightweighting of the differential and makes it easier to install and use in applications such as a transmission. Compared with bolted connection or welding, spline connection provides greater strength, which is beneficial for the differential to meet requirements for transmitting greater torque.
iv. By the match between the mounting portions 31p of the gear shaft 31 and the mounting grooves 13c of the ring gear 1, the gear shaft 31 and the ring gear 1 are directly in transmission connection without needing to connect via the housing, so that the load that the housing needs to bear is very small, thereby placing a lower strength requirement on the housing. In this way, the housing of the differential only serves as a support, and thus the housing of the differential may have a smaller wall thickness to reduce its volume and weight.
v. It is appreciated that, after all the components of the differential are installed in place, the first split part 21 and the second split part 22 are capable of providing axial limits for the gear shaft 31.
vi. The present application also provides a vehicle transmission, which includes the differential described in the above-mentioned specific embodiments, and a power source of the vehicle transmits torque to the wheels via the differential.

The description of the invention is merely exemplary in nature and, thus, variations that do not depart from the gist of the invention are intended to be within the scope of the invention. Such variations are not to be regarded as a departure from the spirit and scope of the invention.

### LIST OF REFERENCE NUMERALS

1 ring gear;
1c1 first ring groove;
1c2 second ring groove;
11 first inner spline;
12 second inner spline;
13 central protrusion;
13c mounting groove;
21 first split part;
211 first outer spline;
212 first tapered portion;
212h first weight-reducing hole;
213 first bearing seat;
22 second split part;
221 second outer spline;
222 second tapered portion;
222h second weight-reducing hole;
223 second bearing seat;
2s mounting space;
3 bevel gear group;
31 gear shaft;
31p mounting portion;
32a first bevel gear;
32b second bevel gear;
33a third bevel gear;
33b fourth bevel gear;
41 first retaining ring;
42 second retaining ring;
51 first bearing;
52 second bearing;
P plane of symmetry;
A axial direction;
R radial direction.

1. A differential, comprising:
a ring gear;
a housing, comprising:
a first split part;
a second split part, the first split part and the second split part having the same structure and define a mounting space;
a bevel gear group accommodated and mounted in the mounting space, the bevel gear group comprising:
a gear shaft which extends along a radial direction of the ring gear and is in transmission connection with the ring gear;
a first pair of bevel gears which are mounted to the gear shaft and are rotatable around the gear shaft; and
a second pair of bevel gears, each of which meshes with at least one of the first pair of bevel gears;
wherein the first split part and the second split part are coaxially arranged with the ring gear and are detachably mounted together with the ring gear, and the first split part and the second split part are respectively in spline connection with the ring gear to implement transmission connection.

2. The differential of claim 1, further comprising:
at least one ring groove integrally formed as part of the ring gear; and
at least one retaining ring;
wherein the at least one retaining ring is mounted to the at least one ring groove for axially limiting the first split part and the second split part.

3. The differential of claim 1, the ring gear further comprising:
at least two mounting grooves;
wherein two axial ends of the gear shaft are respectively inserted into the at least two mounting grooves, thereby enabling the ring gear to directly drive the gear shaft to rotate.

4. The differential of claim 1, further comprising:
a first inner spline being part of an inner circumferential surface of the ring gear;
a second inner spline being part of the inner circumferential surface of the ring gear, the first inner spline and the second inner spline are arranged side-by-side and spaced apart from one another in an axial direction of the ring gear;
a first outer spline being part of the first split part, the first outer spline in mesh with the first inner spline;
a second outer spline being in mesh with the second split part, the second outer spline in mesh with the second inner spline.

5. The differential according to claim 4, further comprising:
a central protrusion being part of the ring gear, the central protrusion located between the first inner spline and the second inner spline in the axial direction;
a first ring groove being part of the ring gear;
a first retaining ring mounted into the first ring groove such that the first retaining ring and the central protrusion are located on two axial sides of the first outer spline for axially limiting the first outer spline;
a second ring groove being part of the ring gear; and
a second retaining ring mounted into the second ring groove such that the second retaining ring and the central protrusion are located on two axial sides of the second outer spline for axially limiting the second outer spline.

6. The differential according to claim 5, further comprising:
at least two mounting grooves integrally formed as part of the central protrusion; and
at least two mounting portions formed as part of two corresponding end portions of the gear shaft;
wherein the mounting portions are inserted into corresponding mounting grooves.

7. The differential according to claim 6, further comprising:
at least two planar side walls integrally formed as part of the mounting groove;
an abutting portion integrally formed as part of the mounting portion, the abutting portion form-fit with and in contact with the two side walls;
wherein the side walls cooperate with the abutting portion to implement transmission connection.

8. The differential of claim 1, further comprising a plane of symmetry perpendicular to the axial direction of the ring gear, and the differential is symmetrical with respect to the plane of symmetry.

9. The differential according to claim 1, wherein the first split part and the second split part are formed by using the same fine blanking apparatus for machining.

10. A vehicle transmission, comprising the differential according to claim 1.
